(19) United States
(12) Patent Application Publication
(10) Pub. No.: US 2013/0147599 A1
(43) Pub. Date: Jun. 13, 2013

(54) WIRELESS CONTROL OF EMERGENCY NOTIFICATION DEVICES

(71) Applicants: Donald Becker, Bradenton, FL (US); Marty (Martin) Camins, Waterloo (CA); Morris Stoops, Bradenton, FL (US); Jeffrey Wyman, Waterloo (CA)

(72) Inventors: Donald Becker, Bradenton, FL (US); Marty (Martin) Camins, Waterloo (CA); Morris Stoops, Bradenton, FL (US); Jeffrey Wyman, Waterloo (CA)

(73) Assignee: UTC FIRE & SECURITY AMERICAS CORPORATION, INC., Farmington, CT (US)

(21) Appl. No.: 13/323,412

(22) Filed: Dec. 12, 2011

(51) Int. Cl. G08B 29/00; G08B 5/22

(52) U.S. Cl. 340/5.61; 340/6.1

(57) ABSTRACT

A system for controlling devices in an emergency system, the system having one or more emergency notification devices and a control device. The emergency notification devices have one or more outputs and are capable of using the one or more outputs for both emergency notification and non-emergency purposes. The control device is used for controlling the outputs of the emergency notification devices, and is wirelessly coupled to the emergency notification devices.

### BACKGROUND

The current invention is related to the control of emergency notification devices, and in particular to a system and method for controlling emergency notification devices remotely.

Emergency systems consist of notification appliance circuits (NACs) that power a plurality of notification devices. Traditionally, a notification device has only been controllable at the device itself, through the use of hardware switches. This is mainly due to the fact that these systems tend not to be used for any purpose other than emergency notification. Therefore, there has been no need to adjust a notification device's settings other than during installation or maintenance.

Various limitations have prevented the use of emergency devices for non-emergency functions in the past. For instance, if a notification device is being used for a purpose other than an emergency, there has been no effective way to supervise the device in order to ensure its functionality during an upcoming emergency. Further, overuse of notification devices may cause a decrease in the devices' reliability. In a normal emergency system, a device will rarely be used. If a device is used for everyday functions, the device may need to be replaced much sooner than if used solely for emergencies.

There is a need to update the technology to allow emergency devices to be used for non-emergency purposes in order to maximize the utility of the system. Non-emergency functions such as paging in a building, or background music in a lobby may be accomplished using audio notification devices. If functions such as these are implemented, it creates a need for end-users to control various output settings of the devices.

### SUMMARY

A system and method that includes wireless control of one or more emergency notification devices. The control device wireless sly communicates with the one or more emergency notification devices in order to control output settings of the one or more emergency notification devices.

### BRIEF DESCRIPTION OF THE DRAWINGS

FIG. 1 is a block diagram that illustrates an embodiment of the present invention.

FIG. 2 is a block diagram that illustrates a control device and an emergency notification device according to an embodiment of the present invention.

FIG. 3 is a flow chart that illustrates a method of controlling a notification device using a control device according to an embodiment of the present invention.

### DETAILED DESCRIPTION

The present invention describes an emergency notification system that allows a user to remotely control one or more outputs of emergency notification devices. The user may be any person, but will typically be an end-user, such as an occupant of a building having an emergency notification system, or an installer of an emergency notification system.

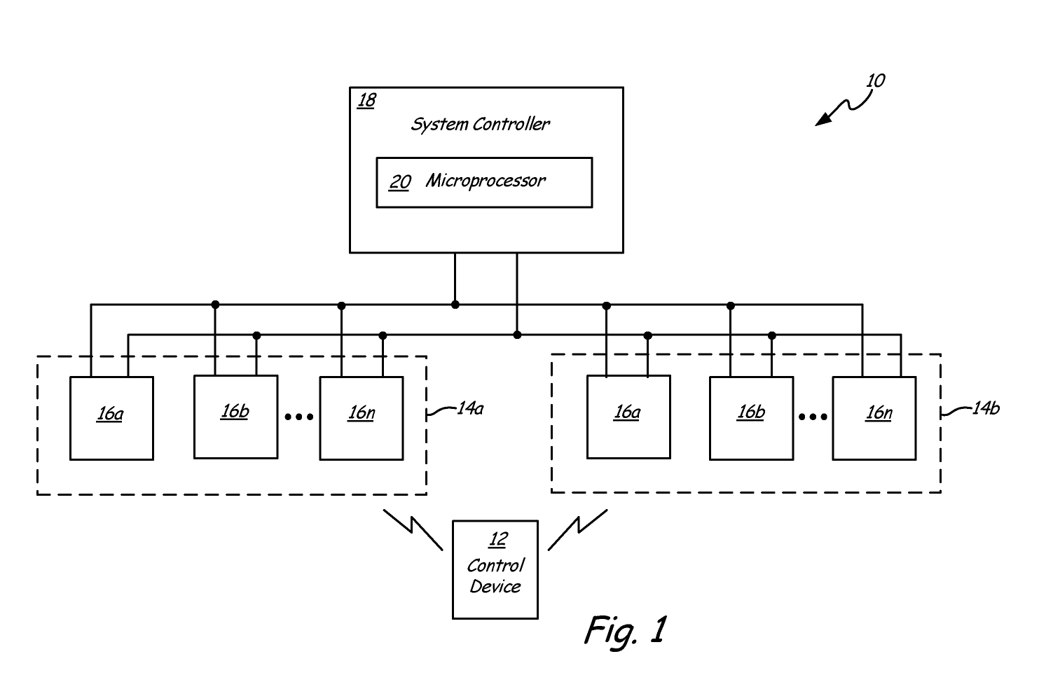

FIG. 1 is a block diagram illustrating an embodiment of emergency system 10. In this embodiment, system 10 includes control device 12, groups 14a-14b, emergency notification devices 16a-16n, and system controller 18. System controller 18 contains microprocessor 20. Emergency system 10 contains two groups 14a-14b, but may contain any number of groups. Each group contains a plurality of notification devices 16a-16n. Each notification device 16a-16n is connected to system controller 18 by a pair of conductors. System controller 18 provides power, command signals, audio signals, and any other signals required for operation to emergency notification devices 16a-16n.

During an emergency, notification devices 16a-16n provide notification to an area affected by the emergency condition. For example, if emergency notification devices 16a-16n have an output speaker, the output speaker may be used as an emergency signal to alert persons in the area of a fire. Input devices such as smoke detectors (not shown in FIG. 1) will detect smoke from the fire and alert system controller 18. In turn, microprocessor 20 of system controller 18 will generate commands and send the commands to notification devices 16a-16n over the pair of conductors. Notification devices 16a-16n will receive the commands and use their respective outputs to alert persons in the area of the fire.

When no emergency condition is present in emergency system 10, notification devices 16a-16n may operate in a non-emergency mode. For example, if emergency system 10 is a fire system, notification devices 16a-16n may be configured to output background music when there is no fire detected in the system. This background music may be sent to notification devices 16a-16n from system controller 18 over the pair of conductors. Emergency system 10 may also be used as a paging system when no emergency condition is present. A page could be sent from system controller 18 over the pair of conductors to each of notification devices 16a-16n. Notification devices 16a-16n could then play the page on their respective output peripherals.

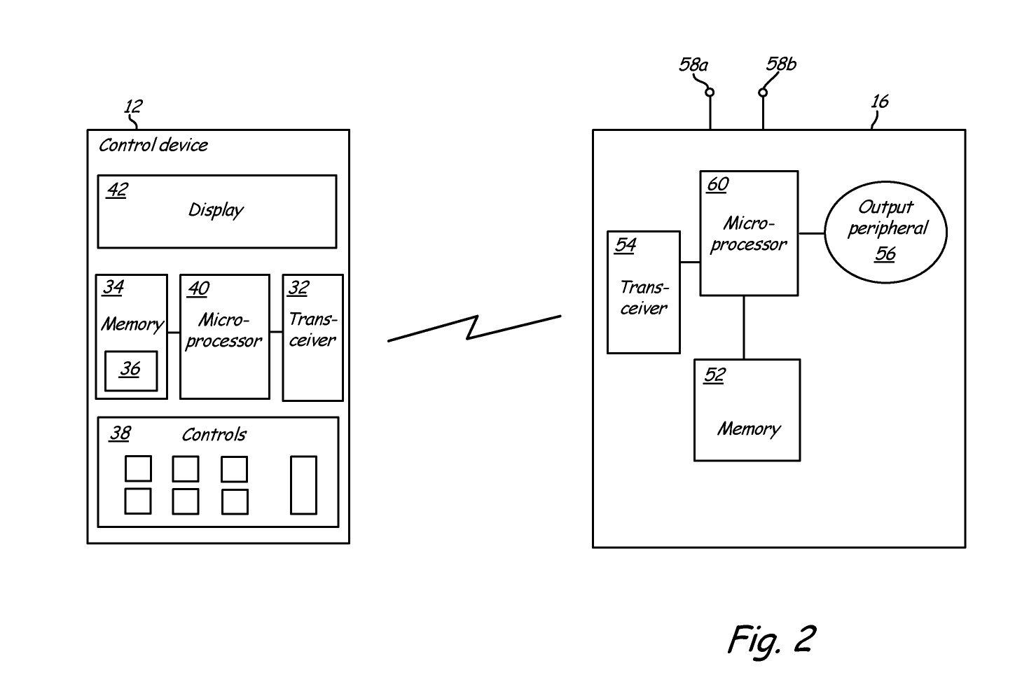

Embodiments of control device 12 and notification device 16 (representative of devices 16a-16n) are depicted in FIG. 2. Notification device 16 includes memory 52, transceiver 54, output peripheral 56, system control inputs 58a-58b, and microprocessor 60. Memory 52 is configured to store an address of notification device 16, identifiers regarding groups of devices of which notification device 16 is a member, and an emergency system identifier. The system identifier indicates the emergency system 10 of which notification device 16 is a member. Output peripheral 56 may be a speaker, LED, or any other type of output peripheral. System control inputs 58a-58b receive power, commands, audio signals, and other information from system controller 18.

Control device 12 includes transceiver 32, memory 34, lookup-table 36, controls 38, microprocessor 40, and display 42. Transceiver 32 is configured to communicate bi-directionally with transceiver 54 of notification device 16. Transceivers 32 and 54 may be radio-frequency transceivers such that control device 12 and notification device 16 can communicate wireless sly. This wireless communication may be accomplished using the Radio Frequency for Consumer Electronics (RF4CE) and IEEE 802.15.4 wireless protocol standards, or any other wireless protocol standards capable of providing bi-directional communication between control device 12 and notification device 16. Controls 38 may be any type of input user interface, such as an array of buttons, or a touch screen.

Control device 12 can only control notification device 16 if control device 12 is permitted to do so. At the time of installation of emergency system 10, an installer programs memory 34 of control device 12 with information regarding which emergency notification devices 16a-16n control device 12 is allowed to control. This information may include validation keys, encryption keys, emergency system identifiers, group identifiers, or addresses of individual notification devices 16a-16n. The programming may be done by the installer wirelessly, for example, by using a laptop computer or other handheld device.

An end-user must select notification devices 16a-16n in range of control device 12 which the end-user wishes to control. Control device 12 can broadcast the identifiers of the notification devices with which it has the authority to control. Each notification device 16a-16n within range of control device 12 will receive the broadcast, and each respective microprocessor 60 will compare the identifiers with its own identifiers stored in its respective memory 52. If the identifiers match, respective microprocessor 60 will send an acknowledgement back to control device 12. Control device 12 may then display on display 42 a list of those notification devices which provided acknowledgements. An end-user, using controls 38, may then choose which notification devices the end-user wishes to control.

For example, referring back to FIG. 1, control device 12 may be configured as an end-user remote control and may be permitted to control only those devices in group 14b. Control device 12 will broadcast the identifiers of those devices belonging to group 14b. If control device 12 is only in range of notification devices 16a-16n of group 14a, each device will receive the broadcast, compare the broadcast with its own stored identifiers, and ignore the broadcast. If both groups 14a and 14b are in range of control device 12, only the notification devices 16a-16n of group 14b will respond to control device 12 with an acknowledgement. Devices 16a-16n of group 14b will be listed on a display of control device 12 so that an end-user may select all devices with which the control device 12 will communicate. There may also be other emergency systems, other than system 10, within range of control device 12. Notification devices of these other emergency systems would ignore any broadcasts from control device 12.

Once an end-user has selected to control notification device 16, control device 12 will provide a validation key so that notification device 16 may validate that control device 12 has authority to control notification device 16. Microprocessor 40 sends the validation key to notification device 16 using transceiver 32. Notification device 16 receives the validation key, and microprocessor 60 compares it with a validation key stored in memory 52. If the validation key provided by control device 12 is not valid, microprocessor 60 of notification device 16 will ignore any further messages or commands sent from control device 12. Communication between control device 12 and notification device 16 may be encrypted, in which case encryption keys would also need to be established by both control device 12 and notification device 16 prior to communication.

Once control device 12 has been validated by notification device 16, control device 12 will store the address of notification device 16 in its lookup-table 36. If the address of notification device 16 is contained in lookup-table 36, control device 12 may communicate with notification device 16. If lookup-table 36 becomes full, notification device addresses are removed from lookup-table 36 on a least-used basis. Once the address of notification device 16 has been removed from lookup-table 36, control device 12 will need to re-validate its authority with notification device 16 before it may continue to communicate with notification device 16.

If programmed as an end-user remote, control device 12 may control non-emergency outputs of output peripheral 56 of notification device 16. This may include controlling the volume of output peripheral 56, if output peripheral 56 is a speaker. Controlling non-emergency outputs is accomplished by microprocessor 40 sending commands from control device 12 to notification device 16. Notification device 16 receives the commands and, if not operating in an emergency mode, microprocessor 60 adjusts the outputs of output peripheral 56.

If programmed as an installer control device, control device 12 may also control the emergency notification outputs of output peripheral 56. This may include the volume of an output speaker when used as an emergency signal, or the brightness of a strobe light. Like an end-user remote, the installer remote will send notification device 16 commands. Notification device 16 will receive the commands, microprocessor 60 will recognize that the commands are received from an installer remote, and microprocessor 60 will adjust the outputs of output peripheral 56 accordingly.

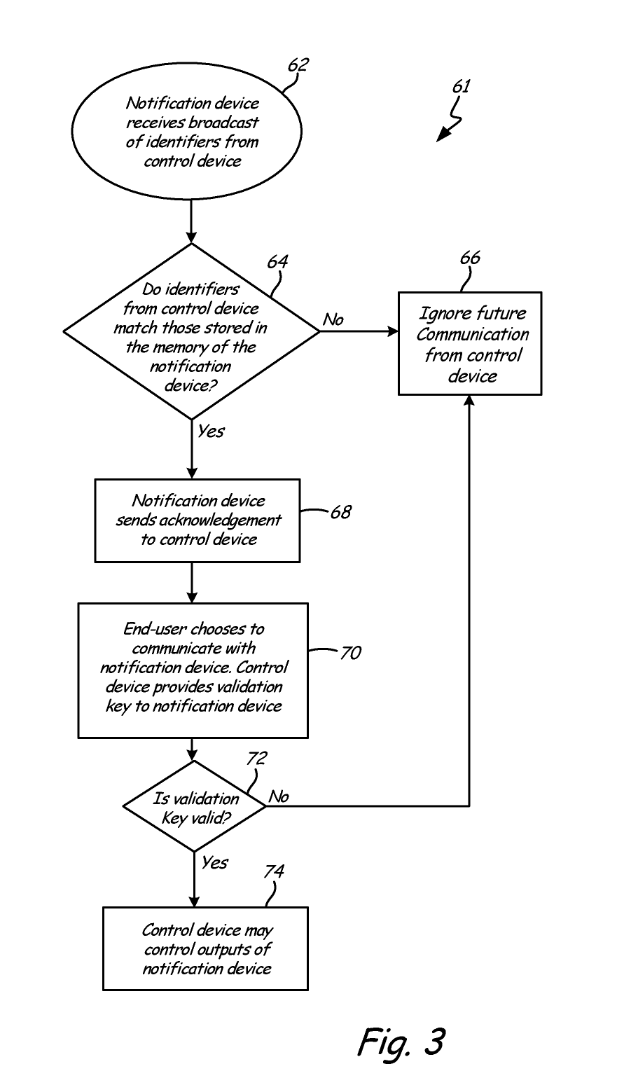

FIG. 3 is a flowchart illustrating a method 61 for controlling output peripheral 56 of notification device 16 remotely using control device 12. At step 62, control device 12 wirelessly broadcasts identifiers of notification devices 16 for which control device 12 has permission to control. Notification device 16 receives the broadcast from control device 12. At step 64, notification device 16 compares the identifiers with those stored in its memory 52. If the identifiers broadcast by control device 12 match those stored in memory 52, method 61 proceeds to step 68. If the identifiers broadcast by control device 12 do not match those stored in memory 52, method 61 proceeds to step 66. At step 66, notification device 16 ignores any future messages from control device 12. At step 68, notification device 16 provides an acknowledgement to control device 12. At step 70, an end-user chooses to communicate with notification device 16 based upon the acknowledgement given by notification device 16. At step 72, control device 12 provides a validation key to notification device 16. If the validation key is invalid, method 61 proceeds to step 66. If the validation key is valid, method 61 proceeds to step 74. At step 74, the end-user controls the outputs of output peripheral 56 of notification device 16.

In this way, the present invention provides a system and method for remotely controlling emergency notification devices. Although the present invention has been described with reference to preferred embodiments, it will be understood by those skilled in the art that various changes may be made and equivalents may be substituted for elements thereof without departing from the scope of the invention.

1. A system for controlling emergency notification devices in an emergency system, the system comprising:
one or more emergency notification devices each having an output peripheral;
a control device configured to communicate wirelessly with the one or more emergency notification devices;
wherein the output peripheral of each of the one or more emergency notification devices provides both emergency notification outputs and non-emergency outputs; and
wherein the control device is configured to control the non-emergency outputs of the output peripheral of each of the one or more emergency notification devices.

2. The system of claim 1, wherein the control device includes a microprocessor, a memory and a radio-frequency transceiver.

3. The system of claim 2, wherein the memory includes a look-up table for storing identification of the one or more emergency notification devices with which the control device communicates.

4. The system of claim 1, wherein the one or more emergency notification devices each further include a microprocessor, a memory, and a radio-frequency transceiver.

5. The system of claim 4, wherein the memory includes a device address, a system identifier, and a group identifier.

6. The system of claim 1, further comprising a system controller wired to the one or more emergency notification devices, the system controller configured to provide power to the one or more emergency notification devices.

7. A method for controlling a notification device in an emergency system, the method comprising:
wirelessly coupling a control device to a notification device, the notification device including an output peripheral, the output peripheral configured to provide both an emergency notification output and a non-emergency output;
validating that the control device has permission to communicate with the emergency notification device; and
controlling the non-emergency output of the output peripheral using the control device.

8. The method of claim 7, wherein the control device includes a radio-frequency transceiver, a microprocessor, and a memory device.

9. The method of claim 7, wherein the notification device further includes a radio-frequency transceiver, a microprocessor, and a memory device.

10. The method of claim 7, wherein wirelessly coupling the control device to the emergency notification device comprises:
comparing identifiers sent from the control device with identifiers stored in the memory device of the notification device; and
sending an acknowledgement to the control device if the identifiers from the control device matched the identifiers stored in the memory device of the notification device.

11. The method of claim 7, wherein validating that the control device has permission to communicate with the emergency notification device comprises:
sending a validation key from the control device to the notification device; and
comparing the validation key sent from the control device with a validation key stored in memory of the notification device.

12. An apparatus for controlling outputs of one or more emergency notification devices, the apparatus comprising:
a transceiver capable of communicating wireless sly with the one or more emergency notification devices;
a memory capable of storing identifiers of the one or more emergency notification devices; and
controls for controlling the outputs of the one or more emergency notification devices.

13. The apparatus of claim 12, the outputs of the one or more emergency notification devices include both emergency notification outputs and non-emergency outputs.

14. The apparatus of claim 13, wherein the controls for controlling the outputs of the one or more emergency notification devices only operate to control the non-emergency outputs.

15. The apparatus of claim 14, wherein controlling the non-emergency outputs includes adjusting volume of a speaker.
